(19) United States
(12) Patent Application Publication
(10) Pub. No.: US 2004/0187138 A1
(43) Pub. Date: Sep. 23, 2004

(54) Device and installation for the centralised management of messaging data

(75) Inventor: Emmanuel Desurvire, Escobille (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/698,467

(22) Filed: Nov. 3, 2003

(30) Foreign Application Priority Data
Nov. 4, 2002 (FR) 02 13 736

(51) Int. Cl. G06F 9/00; G06F 9/46

(52) U.S. Cl. 719/319; 719/313

(57) ABSTRACT

A messaging data management installation comprises i) messaging means (3, 5) able to receive messaging data in correspondence with user identifiers, ii) messaging data broadcast means (17-20), iii) at least one device (10) able to deliver a primary identifier representing a user identifier, iv) detection means (9-j) capable of detecting primary identifiers delivered by the device (10) and transmitting them, and v) management means (1, 8) capable, whenever they receive a primary identifier transmitted by the detection means (9-j), of determining the associated user identifier, and then seeking amongst the messaging data received by the messaging means (3, 5) those which are associated with the user identifier determined and, when such data are present, ordering their broadcast by at least one of the broadcast means (17-20).

The invention concerns the field of messaging, and more particularly that of managing messaging data.

Messaging data means here data constituting a message, whether it be in the form of fixed or concatenated image(s), text or sound recording.

It is becoming more and more frequent for persons to have several messaging services, such as for example one or more telephone messaging services and/or one or more electronic messaging services, of the electronic mail (or e-mail) or facsimile type. Since consulting these various messaging services requires many operations, in particular connection operations, on machines which are possibly different located at possibly different points, systems have been proposed making it possible to group together all the messages concerning the same user in a unified “mailbox”. This is particularly the case with the Nextenso system from Alcatel. Thus, in order to access all his messages the user now merely has to connect to the messaging grouping system, via a communications terminals such as a mobile telephone, for example of the GPRS or UMTS type, or a fixed or portable computer.

This type of system is certainly particularly advantageous, but it still constrains the user to perform operations which prevent him, in practice, from doing anything else simultaneously. In other words, the current systems do not allow functioning of the “hands-free” type. In addition, the use of these systems via mobile terminals, such as mobile telephones, remains difficult, in particular when it is a case of reading fairly long messages or displaying fixed or concatenated images.

The aim of the invention is therefore to improve the situation.

It proposes for this purpose a messaging data management installation comprising:

messaging means able to receive messaging data in correspondence with user identifiers,

one or more broadcast means (by display and/or acoustically),

at least one device capable of supplying a primary identifier representing a user identifier,

detection means capable of detecting primary identifiers delivered by the device and transmitting them, and

management means capable, whenever they receive a primary identifier transmitted by the detection means, of determining the associated user identifier, and then seeking amongst the messaging data received by the messaging means those which are associated with the user identifier determined and, when such data are present, ordering their broadcast by at least one of the broadcast means.

Thus, as soon as the device of a user is detected, the management means are immediately advised of this and they can determine from amongst the messages received by the various messaging means all or some of those which are associated with the primary identifier of the device, so that any messages are broadcast without the user having to perform the slightest operation.

The installation according to the invention can comprise many supplementary characteristics which can be taken separately and/or in combination, and in particular:

detection means able to comprise a multiplicity of sensors, located at chosen points in zones in which users equipped with a device can circulate, coupled to the management means and capable of interacting with each device in order to obtain the associated primary identifier. In this case, it is advantageous to provide a multiplicity of broadcast means (by display and/or acoustically) each associated with one of the zones. In addition, firstly, each sensor can advantageously be associated with a secondary identifier and capable of transmitting to the management means the primary identifier detected and its own secondary identifier, secondly, each broadcast means can be associated with a tertiary identifier, itself associated with at least one secondary identifier, thirdly the installation can also comprise a memory storing the secondary identifiers in correspondence with each tertiary identifier, and fourthly the management means can be arranged, whenever they receive a pair of primary and secondary identifiers, so as to extract from the memory the tertiary identifier associated with the secondary identifier received, so that the messaging data associated with the user identifier associated with the primary identifier received can be broadcast by the broadcast means which is associated with the tertiary identifier extracted from the memory;

at least some of the broadcast means can be display means, such as for example monitors (flat screens or television sets) or communications terminal monitors (fixed or portable computer or fixed or mobile telephone) connected to a telephony network. In a variant, or in addition, certain display means can be image data projectors;

at least some of the broadcast means can be acoustic broadcast means, such as for example loudspeakers;

messaging means comprising first electronic messaging means and second telephonic messaging means. Such first electronic messaging means can be at least partially located in a communications terminal connected to an electronic messaging server via a first communications network. Likewise, the second voice messaging means can be at least partially located in a telephone possibly connectable to a voice messaging server via a second communications network. Naturally, the first and second communications networks can be identical, and it may be a case of public communications networks, for example of the PSTN, PLMN, i-Mode or Internet (IP) type, or private networks, for example of the PABX or private communications gateway type;

transmission means coupled at least to the management means, to the broadcast means, and to the detection means. These transmission means can be chosen from amongst means of transmission by wave (such as for example infrared transceivers) and by cable (such as for example data exchange buses);

each detection means can be arranged so as to effect a presence detection in at least part of the zone in which it is located, so as to send signals to devices only in the event of presence detection;

several devices being able to be associated with different primary identifiers;

devices being able to be of the passive type;

devices being able to be arranged so as to transmit their primary identifier by waves. In this case, the transmission can be effected spontaneously, for example periodically, or in response to signals transmitted by waves by the detection means;

each device can comprise a component which, when it is actuated by a user, makes it possible to activate or deactivate its functioning;

first conversion means capable of converting messaging data of the text type into messaging data of the audible type;

second conversion means able to make it possible to convert messaging data of the audible type into messaging data of the text type;

acoustic pick-up means coupled to the management means and capable of picking up speech sent by a user and converting it into digital data. In this case, the management means are advantageously capable, when they receive such digital conversion data, to generate, for messaging means, commands representing messaging operations to be performed. Amongst these messaging operations it is in particular possible to cite the response to a chosen message, the saving or deletion of a chosen message, the selection of a chosen message from amongst a list of messages previously displayed in the form of icons by means of at least one of the display means or present in voice form by means of the acoustic broadcast means, with a view to the display of the data on at least one of the display means or the broadcast of the sound data by means of these acoustic display means, the enlargement of the text or image data of a chosen message, the rebroadcast of the sound data of a chosen message, the opening of a file attached to a chosen message, and text scrolling;

management means being able to be of the configurable type. In this case the configuration can relate to the messaging means interrogation mode (for example of the periodic type) and/or to a first type of messaging data to be broadcast (for example representing a first priority level which is a function of the address of the sender of the messaging data) and/or to a second type of messaging data to be broadcast (for example representing a second priority level which is a function of the user identifier associated with a primary identifier received). In addition, the management means can be configured via a terminal user interface.

The invention also concerns a messaging data management device comprising management means able to be used in an installation of the type presented above. Such a device can also comprise the first and/or second conversion means presented above.

Other characteristics and advantages of the invention will emerge from an examination of the following detailed description, and the accompanying drawings, in which:

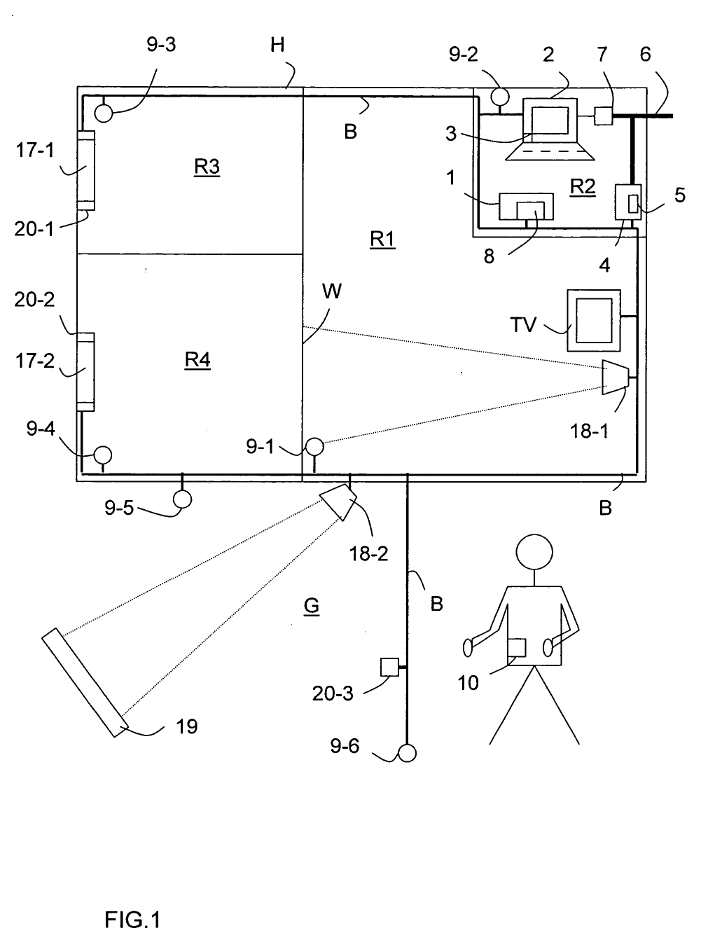

FIG. 1 illustrates schematically an example of an installation according to the invention, located in a house,

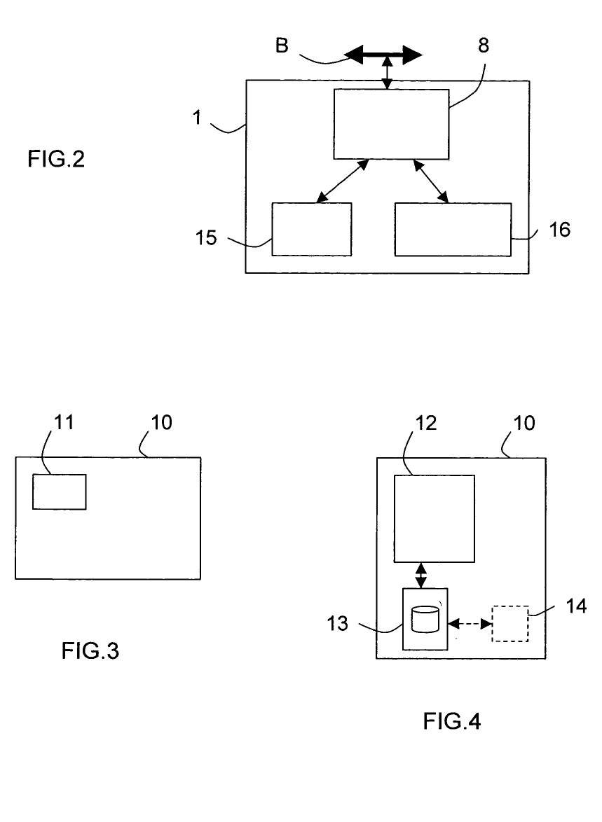

FIG. 2 illustrates schematically an example embodiment of a data management box of the installation according to the invention,

FIG. 3 illustrates schematically a first example embodiment of a presence indicating device of the installation according to the invention; and

FIG. 4 illustrates schematically a second example embodiment of a presence signalling device of the installation according to the invention.

The accompanying drawings can not only serve to supplement the invention but also contribute to its definition, where necessary.

Reference is made first of all to FIGS. 1 and 2 to describe an example embodiment of a messaging data management installation according to the invention.

In this example, the installation is located in a house H surrounded by garden G and comprising four dwelling rooms Ri (i=1 to 4). Naturally the invention is not limited to this example of a location. It applies in general terms to any type of premises in which persons can move about, and in particular business premises, whether it is a case of offices, experimentation rooms or factories. In fact, the invention is particularly well suited to all environments in which the reading or listening to messages must take place without manual intervention, or with a minimum of basic manual interventions, as is in particular the case in clean rooms or confined enclosures.

The installation comprises first of all a management device 1 which, in this example, is produced in the form of a dedicated box. This device 1 is intended to manage messaging data which are received by messaging modules located, at least partially, in communications terminals. Here there is provided firstly a computer 2 equipped with a first messaging module 3, such as for example the reception box made available by the Internet access provider to which the user subscribes, which enables him to send and receive electronic messages (for example of the e-mail type, with any attached files, or of the audio and/or video type), and secondly a telephone 4 equipped with a second messaging module 5, such as for example an analogue or digital responder, which enables him to receive and record sound messages. The responder generally has the drawback of recording messages independently of the identifier of their author (or caller).

The telephone 4 is connected to a telephone network, for example of the PSTN type, via a connection 6. In addition, the computer 2 is connected to the messaging server of its Internet access provider, via a modem 7, the connection 6 and the telephone network. In this example, the telephone 4 and computer 2 are connected to the same communication network, but this could be different. Moreover, in this example the first messaging module 3 is intended to receive messages of the e-mail type, but it can be envisaged that this first messaging module 3 be all or part of a unified messaging device, such as for example the aforementioned Nextenso system, thus making it possible to recover, in a single mailbox, messages of various types (e-mail, audio, video, facsimile and the like). It can even be envisaged that there be only one messaging module providing the functions of the first 3 and second 5 messaging modules.

The messaging data, in particular those received by the first messaging module 3, are associated with a user identifier and stored in a memory in correspondence with their user identifier in order to be able to be read at any time.

The management device 1 comprises a management module 8 responsible, when it is acted on, as will be seen later, for seeking, amongst the messaging data received by the first 3 and second 5 messaging modules, those which are associated with a primary identifier representing a user identifier, previously determined by detection means 9-j (here j=1 to 6).

The detection means are, for example, sensors 9-j each responsible for detecting, in chosen zones, the presence of presence signalling devices 10 equipping users. For example, as illustrated, each room Ri is equipped with a sensor 9-j, whilst the garden G is equipped with two sensors (9-5 and 9-6) preferably associated with at least partially different detection zones.

In the absence of any garden, it can be envisaged equipping other internal or external private places, such as for example a cellar or a car park.

Each presence signalling device 10 is associated with a primary identifier representing a user identifier. In addition, each presence signalling device 10 is responsible for interacting with the sensor 9-j in the detection area in which it is situated, so that it can determine its primary identifier. To do this several types of interaction can be envisaged.

In a first embodiment, illustrated in FIG. 3, the presence signalling device 10 is of the passive type. It consists for example of a card containing an electronic chip 11 in which the data representing the primary identifier associated with the said card are stored. In this case, the sensors 9-j are equipped so as to remotely read the primary identifier stored in the chip 11. They consist for example of an infrared transceiver of the type used in the field of access control to premises or toll motorways.

However, naturally, any other means capable of obtaining information at a distance making it possible to go back to the primary identifier associated with the card 10, without the latter being obliged to have recourse to an inherent energy source, can be envisaged. Thus it is possible to envisage an interaction by electromagnetic induction, or even an optical interaction should the presence signalling device 10 be equipped with a device being able to be read by an optical reader, such as for example a hologram, a barcode or the like.

It is however preferable, in this embodiment, for the sensor 9-j to be capable of interacting with the card 10 through clothing or bags, so that the card user does not have to manipulate it or attach it outside his clothing.

In a second embodiment, illustrated in FIG. 4, the presence signalling device 10 is of the active type. It consists for example of a small dedicated box containing a simple transmitter or a transceiver 12, for example of the infrared type, capable of transmitting by waves to sensors 9-j data representing the primary identifier associated with the said box. In this case, the box comprises a self-contained power source 13, such as for example a small battery, coupled to the transmitter or to the transceiver 12.

If the box 10 comprises a simple transmitter 12, two cases can be envisaged. In the first case, the sending of data representing the primary identifier takes place spontaneously, for example periodically (typically every second). The sensors 9-j can therefore be of particularly simple design since they do not need to function in transmission in order to interact with the presence signalling devices 10. In addition, this makes it possible to produce presence signalling devices 10 which are particularly simple but have high energy consumption, all the more so since the power required in transmission must be relatively high if it is wished for it to pass through clothing or bags for the reasons mentioned above. A variant of this solution consists of equipping the sensors 9-j with a transceiver responsible for transmitting activation signals and secondly the transmitter 12 of the presence signalling devices 10 with a standby mechanism capable of being activated by the activation signals which they receive when they are in the detection zone of a sensor.

In the second case, as illustrated in broken lines in FIG. 4, the presence signalling devices 10 are equipped with an activation device 14 coupled to the supply source 13 and being able to be actuated by a user so as to activate and deactivate, for example by pressure, the supply to the transmitter 12 to enable it to transmit or prevent transmission. As in the previous case, the sensors 9-j can be of particularly simple design since they do not need to function in transmission in order to interact with the presence signalling devices 10. In addition, the presence signalling devices 10 remain of simple design, and their power consumption can be controlled by the user.

If the box 10 comprises a transceiver 12, two cases can also be envisaged. In the first case, the box 10 transmits data representing the primary identifier in response to a message transmitted by a sensor 9-j, which must consequently be equipped with a transceiver. Preferentially, the message transmitted by the sensor 9-j consists of activation signals intended to activate a standby mechanism coupled to the power supply source of the box 10, as indicated before. However, in a variant, the transceiver 12 of the box can be supplied continuously.

In the second case, as illustrated in broken lines in FIG. 4, the presence signalling devices 10 are equipped with an activation device 14 coupled to a power supply source 13 and able to be actuated by a user so as to activate and deactivate, for example by pressure, the supply to the transmitter 12 to enable it to transmit or prevent transmission. Once supplied, the transceiver 12 of a box 10 is then in a position to respond to the messages which it receives from a sensor when it is placed in its detection zone.

The determination of the primary identifier associated with a presence signalling device 10 can possibly be preceded by a detection of presence of the user who is equipped with this device, by the sensors 9-j. It is in particular advantageous when the presence signalling device 10 does not transmit its primary identifier “continuously” (or spontaneously). Any type of detection suited to the place which is the subject of the surveillance can be envisaged and particularly those normally used in the field of surveillance of premises or the surroundings of premises, such as for example car parks.

In this case it is only once a sensor 9-j has detected the presence of a person in its detection zone that it is initiates the phase of determining the primary identifier of the presence signalling device 10 which possibly equips the detected person.

When a sensor 9-j is in possession of the data representing the primary identifier of a presence signalling device 10, it must communicate it immediately to the management device 1 and more precisely to its management module 8 so that it processes them. Any type of transmission can be envisaged, whether it be by cable or waves, provided that it is adapted to the configuration of the place. In the case of a transmission by cable, as illustrated in FIG. 1, it is for example possible to use an electronic or optical bus B. In the case of a transmission of a waves, it is possible for example to use the “Bluetooth” radio technology or infrared, possibly locating relays at appropriate points. A combination of several types of different transmission can also be envisaged, including mixed transmission (by cable and by wave), in particular in the context of applications located in distant places or premises.

All the installation equipment is therefore preferentially connected via the transmission means (here a bus B) to the management device 1. However, it can be envisaged that the connection between the management device and the computer 2 and/or the telephone 4 takes place in another way, for example by a radio mechanism, such as Bluetooth, or infrared.

When the management module 8 receives data representing the primary identifier of a presence signalling device 10, it must first of all determine the user identifier which is associated with this primary identifier. To do this, as illustrated in FIG. 2, the management device 1 preferentially comprises a first memory 15 in which a table of correspondence between primary identifiers and user identifiers is stored. Naturally, in a variant, the first memory 15 could be located elsewhere than in the management device, such as for example in the computer 2.

By accessing the first memory 15, the management module 8 can determine the user identifier or identifiers which are associated with the primary identifier received. Once in possession of the user identifier, the management module 8 must determine whether the various messaging modules (here the first 3 at least partially located in the computer 2 and the second 5 at least partially located in the telephone 4) have received messages associated with the identifier of the user determined in the first memory 15. To do this two cases can be envisaged according to the chosen method of obtaining a message.

The messages can in fact be stored in one or more messaging servers accessible via the communications connection 6, or in the memories associated with the first 3 and second 5 messaging modules, or in a second memory 16 of the management device 1, as illustrated in FIG. 2. This results from the fact that the communications equipment 2 and 4 is not necessarily in permanent operation, or when it is the case that their messaging modules are not necessarily in a stand-by state (a situation in which they automatically receive the messages from the messaging servers in order to store them in a memory). In addition, it can be envisaged that the management module 8 is arranged so as to periodically interrogate, for example every hour or once a day, the first 3 and second 5 messaging modules so that they communicate to it, with a view to storing them in a the second memory 16, all the messages which they have received associated with their respective user identifiers, or so that they seek the said messages in the messaging servers. In the latter situation, when the equipment 2 and 4 in which the messaging modules 3 and are located is not necessarily in operation at the time of interrogation, it can be envisaged that the management module 8 sends a connection establishment command to them.

A first case therefore concerns the situation in which the messaging modules 3 and 5 continuously or regularly receive the messages which are intended for them. In this case, either the management module 8 is configured so as to regularly interrogate the messaging modules 3 and 5 in order to store any messages thereof in the second memory 16, independently of the reception of a primary identifier, or the management module 8 is configured so as to interrogate the messaging modules 3 and 5 in order to store their messages in the second memory 16, when it receives a primary identifier. Once the messages are stored in the second memory 16, the management module 8 can then determine those which are associated with the user identifier and then extract them in order to send them to broadcast means, which will be referred to again later.

In a variant, the second memory 16 can be dispensed with. In this case, the management module 8 determines, in each of the messaging modules 3 and 5, whether they have received messages associated with the user identifier, and in this case it extracts them in order to send them to the broadcast means.

In addition, the second memory can be located (shared), for example, in the computer 2.

A second case concerns the situation in which the messaging modules 3 and 5 are not connected to their respective remote messaging servers. In this case, the management module 8 sends to them a command for the establishment of a connection and the extraction of all the messages, independently of the user identifier used, or only messages associated with the determined user identifier. Once the messages are repatriated in the first 3 and second 5 messaging modules either they are stored in the second memory 16 and then possibly selected according to the user identifier determined, or they are directly selected and extracted at the first 3 and second 5 messaging modules, and then sent to the broadcast means.

The purpose of the primary identifier detection made by the sensors 9-j is to allow the “real-time” broadcast, by the broadcast means (by display and/or acoustically), of any messages intended for the user whose presence signalling device 10 has been detected.

To this end, the management installation comprises at least one broadcast means coupled, via the transmission means (here a bus B), to the management device 1, or at least to the messaging modules 3 and 5 (when the messages are not stored in the second memory 16).

Preferably, as illustrated in FIG. 1, several broadcast means are provided, and more preferentially still at least one broadcast means is provided in each of the main living rooms Ri as well as possibly in the garden G (or in general terms in an internal or external private area). In this way, any messages intended for the “detected” user can be broadcast by at least one of the broadcast means of the installation. It is however particularly advantageous to broadcast the messages using the broadcast means which is situated close to (or in the vicinity of) the sensor 9-j which detected the presence signalling device 10 of the user. To this end, there are associated, firstly, with each sensor 9-j a secondary identifier, and secondly, with each broadcast means, a tertiary identifier, itself associated with at least one secondary identifier. These identifiers are preferentially stored in a second table of correspondence for secondary identifiers and tertiary identifiers of the first memory 15.

In this case, when a sensor 9-j detects a primary identifier, it transmits to the management module 8 not only the data representing this primary identifier but also the data representing its own secondary identifier. On reception of these data, the management module 8 firstly determines the messages associated with the user identifier which is associated in the first table of correspondence with the primary identifier received, and secondly determines the tertiary identifier which is associated in the second table of correspondence with the secondary identifier received. In this way, any messages intended for the user can be sent via the bus B to the broadcast means which is associated with the sensor 9-j which detected the presence signalling device 10 of this user.

An example embodiment of the installation in which the message broadcast means are display means is described below.

In the example installation in FIG. 1, three types of display means have been illustrated. A first type consists of electronic flat-screen monitors 17-1 and 17-2, for example of the LCD or plasma type, respectively located in the rooms R3 and R4. A second type consists of the screen of the monitor of the computer 2 located in the room R2. A third type consists of projectors 18-1 and 18-2, respectively located in the room R1 and in the garden G. In the example illustrated, the images generated by the projectors 18-1 and 18-2 are respectively displayed on a white wall W in the room R1 and on a synthetic screen 19 installed in the garden G. It can also be envisaged using the television set TV installed in the room R1 in replacement for or in addition to the projector 18-1.

By way of illustrative example, if the sensor 9-6 detects the arrival in the garden G of a user equipped with a presence signalling device 10, the management module 8 causes the display of any messages intended for this user on the synthetic screen 19, by means of the projector 18-2. On the other hand, if the user is “detected” in the room R1 by the sensor 9-1, any messages which are intended for him are displayed on the wall W by means of the projector 18-1 (and/or on the screen of the television set TV).

Moreover, in this embodiment with selective display, it is preferable for the display at one of the display means to cease as soon as the presence signalling device 10 is no longer in the detection zone of the sensor 9-j. In other words, the management module 8 is arranged so as to allow the display of messages at a display means as long as it receives data from the associated sensor 9-j. This thus makes it possible to follow the user in his movements whilst leaving free the display means to which he can no longer have access. For example, when the user leaves the detection zone of the sensor 9-6 in order to enter the room R1, the said sensor 9-6 no longer transmits data to the management module 8, whilst the sensor 9-1 commences to transmit data to it. This results in the stoppage of the display of the messages on the synthetic screen 19 and the start of the display of these same messages on the wall W by means of the projector 18-1 (and/or on the screen of the television set TV).

Some messages can be of the audible type (this is particularly the case with telephone messages), and they can either be displayed after a conversion of the voice/text type, or broadcast, by means of acoustic broadcast means such as loudspeakers 20-1 to 20-3, in the room Ri or the garden G where the user of the presence signalling device 10 is detected. It may of course be a case of loudspeakers integrated in a flat-screen monitor 17 or in a computer 2, or at least partially independent elements. As will be seen later, these loudspeakers 20 can possibly be located in a box also comprising a microphone connected to the management module 8. Just like the display means, a tertiary identifier is associated with each acoustic broadcast means, and in this case the various tertiary identifiers of the acoustic broadcast means are associated with the secondary identifiers within the second table of correspondence.

In order to provide the conversion of the voice/text type, a first conversion module is provided, preferably located in the management device 1, coupled to the management module 8.

It is also possible to provide a second conversion module of the text/voice type in order to convert text messaging data (or messages) into audible data. Such a module is then located, preferably, in the management device 1, coupled to the management module 8. By virtue of such a conversion of the text/voice type, it is possible to envisage an installation with no display means, and solely provided with acoustic broadcast means 20. In this case, all the text messages are the subject of a prior text/voice conversion before being broadcast via loudspeakers (or any other acoustic means, such as for example an earphone connected to the presence signalling device, or even the sound output of the mobile telephone of the user) and the second table of correspondence stores the correspondence between the secondary identifiers of the sensors 9-j and the tertiary identifiers of the acoustic broadcast means 20.

In the above, it is a question of a routine display of the messages following on from the identification of a user. However, it is possible to envisage a variant in which the display of the messages intended for the identified user is effected when the latter delivers an authorisation (or an order) to the management module 8. In this case, once the user is identified, it is possible for example to display on the screen, associated with the zone in which the user has been identified, information indicating to him whether a message intended for him is waiting. By way of example, the presence of at least one message may be indicated by a blue square (possibly flashing) whilst the absence of a message can be signalled by a black square (possibly flashing). It is also possible to envisage that messages of high priority are signalled by a red square (possibly flashing). In a variant, and when there are acoustic broadcast means, it is possible to envisage that the user identified be advised by an audible message.

If the user wishes to see (or hear) his messages, he then sends a predefined instruction to the management module 8, by voice (for example by pronouncing the word “display” or by activation of a dedicated key if this option is provided on his presence signalling device 10 (this requires at least that it be equipped with a self-contained power supply and a transmitter and that the installation be equipped with reception means capable of receiving the instruction data sent). In the case of a voice instruction, this can be picked up by a microphone located in the detection zone, for example in a box also comprising a loudspeaker, or in the presence signalling device 10 (when this is equipped with a self-contained power supply and a transmitter and the installation is equipped with reception means capable of receiving the instruction data sent).

If the user does not wish to see (or hear) his messages either he does not send an instruction or he sends to the management module 8 a predefined instruction, by voice (for example by pronouncing the word “stop” or by activation of a dedicated key if this option is provided on his presence signalling device 10.

Such an arrangement can also make it possible to deactivate the display when the user remains in a detection zone but no longer wishes to see or listen to his messages. To this end, he can for example send to the management module 8 a predefined instruction, by voice (for example by pronouncing the word “stop” or by activation of a dedicated key if this option is provided on his presence signalling device 10.

Moreover, in the above, it was a question of a functioning of the installation in “mono-session” message mode. However, the invention also applies to functioning in “multi-session” mode. This functioning can be envisaged more particularly when the broadcast of the messages takes place selectively according to the detection zone. In this case, it is in fact possible to configure the management module 8 so that it manages the broadcasting of messages, associated with different user identifiers, by different broadcast means.

It is also possible to configure the management module 8 so that it manages conflicts between users present in the same detection zone. To do this, it suffices to establish a hierarchy (or a priority level) between the user identifiers of the various users, and then to supply this information to the management module 8. Thus, when two users are in the same room it is the one who has the highest priority level who benefits from the broadcast as soon as he is detected by the sensor 9-j for this room.

In addition, it is also possible to configure the management module 8 so that it manages priority levels between messages of different types and/or different groups of addresses. In this case, the management module 8 can cause the broadcast of the messages according to their priority level or filter certain types of messages so that they are not broadcast immediately.

In addition, the installation can also comprise acoustic pick-up means, such as microphones, placed in the vicinity of at least some of the detection zones and coupled to the management module 8 via the transmission means (here the bus B). Such acoustic pick-up means can enable a user to send voice commands to the management module 8 so that he performs processing operations on the messages which have been proposed to him. Any type of operation can be envisaged, and in particular the deletion of a message, the rebroadcast of a message, the saving of a message, the scrolling of a text and the opening of a file attached to a message. However, it is also possible to envisage a command for replying to a message either by voice or by text, for example after a conversion of the voice/text type.

It is also possible to configure the management module 8 so that it causes the initial display only of icons representing the messages for example by a number or a letter, possibly accompanied by a priority level and/or a title and/or the name of the author of the message. In addition, in order to facilitate the selection of the icons, they can also be personalised according to the author of the associated message (this naturally requires prior programming of the management module 8). Thus the user can make his own selection amongst the various icons and request the management module 8 by vocally providing their number of letter, to display the text and/or the images of the corresponding message. It is also possible to provide a command intended to cause the enlargement or reduction of at least part of a displayed message.

The use of voice commands can also enable the activation of the broadcast subject to the communication of a password by the user. In this case, the password is also preferably stored in the first memory 15 in correspondence with the primary identifier and the associated user identifier.

The use of voice commands can also allow interactive dialogue between the user and the management module 8, in particular, as indicated previously, for starting a “broadcast session” ordering the display (or the audible broadcast) of the messages or for the ending of a session, but also for the selection of messages or the sending of instructions representing messaging operations and/or archiving to be carried out. For example, the management module 8 can cause the display on the screen (or the broadcasting by the loudspeaker) associated with the detection zone, of questions to which the user replies orally, and repeat, where necessary after a certain waiting time (either on a screen via a bar menu, for example, or orally in the form of an abbreviated list, for example), the pertinent commands which are offered to the user at the time of the session where he is situated, such as for example continue, terminate, return, pause, and the like.

The configuration of the management module 8 can be carried out directly at the management device 1 when the latter is equipped with a user interface, or by means of a fixed or portable computer when the latter is equipped with the corresponding configuration program. Configuration means here firstly the programming of the operating mode of the management module (periodic interrogation or on reception of a primary identifier), secondly the supply of the first and possibly second tables of correspondence, and thirdly the programming of any different priority levels (according to the users and/or according to the message type or types). It is also possible to envisage the detection sensitivity of the sensors being programmable.

In the above description, reference was made to a relatively complex messaging data management installation. However, the installation according to the invention can take many other forms provided that it comprises as a minimum:

messaging means able to receive messaging data in correspondence with user identifiers,

one or more messaging data broadcast means,

at least one device capable of supplying a primary identifier representing a user identifier,

detection means capable of detecting primary identifiers delivered by the device and transmitting them, and

management means capable, whenever they receive a primary identifier transmitted by the detection means, of determining the associated user identifier and then seeking amongst the messaging data received by the messaging means those which are associated with the user identifier determined and, when such data are present, ordering their broadcast by at least one of the broadcast means.

The management device 1 can be entirely or partially produced in the form of electronic circuits (hardware), software or computer modules (software) or a combination of circuits and software. In addition, it can be located in a dedicated box, as illustrated in FIG. 1, or in equipment in the installation such as for example a fixed or portable computer, or even a fixed or mobile telephone.

The invention is not limited to the embodiments of an installation and a management device described above, solely by way of example, but encompasses all variants which could be envisaged by a person skilled in the art in the scope of the following claims.

Thus an installation has been described dedicated solely to the management of messages, but the invention could also provide the detection of intrusion. This is because, when the sensors provide both presence detection and identification, it may be envisaged that, in the case of the detection of presence not followed by an identification, the sensors send to the management module a message indicating an intrusion, so that the latter triggers one or more alarms. It can also be envisaged that the presence signalling device also constitutes a means of access to premises or equipment, such as is in particular the case with electronic keys in the “bank card” format. In this case, the reading device which equips the premises or equipment is coupled to the management means and also preferably provides identification of the user.

Moreover, an installation has been described providing management of messages in several rooms in a building. However, the invention also applies to installations which provide the management of messages only in one room or in a single internal or external zone. Consequently an installation can be envisaged comprising solely one communication station, such as a fixed or portable computer, equipped with messaging means and a management module according to the invention (either integrated or connected by wire or waves), and detection means coupled to the said management means, as well as a presence signalling device able to equip a user.

In addition, applications have been described in which messages could be read, or not, by an identified user for whom they were intended, without this causing any action at the management module. However, applications can be envisaged in which the management module associates with each message submitted to the user an identifier which it records, possibly in a certified form. It can also be envisaged that the management module be coupled to one or more items of equipment to which the user can gain access or which he can use only provided that he has read or heard a message. For example, this access arrangement related to a “non-repudiation” can make it possible to state the security conditions to be complied with inside a zone in which a user wishes to enter, or to communicate to a visitor certain information (general or personalised) which it is essential for him to know. It is also possible to envisage applications involving individualised training or group presentation (such as for example in the context of an interactive guided tour within an industrial complex, or a factory), or game and/or security and/or educational applications (for example in the context of visits to regional nature parks or leisure centres).

1. A messaging data management installation, characterised in that it comprises messaging means (3, 5) able to receive messaging data in correspondence with user identifiers, at least one messaging data broadcast means (17-20), at least one device (10) capable of delivering a primary identifier representing a user identifier, detection means (9-j) arranged to detect primary identifiers delivered by the said device (10) and to transmit them, and management means (1, 8) capable, whenever they receive a primary identifier transmitted by the said detection means (9-j), of determining the associated user identifier, and then seeking amongst the messaging data received by the said messaging means (3, 5) those which are associated with the user identifier determined and, when such data are present, ordering their broadcast by at least one of the broadcast means (17-20).

2. An installation according to claim 1, characterised in that the said detection means (9-j) comprise a multiplicity of sensors, located at chosen points in zones in which users equipped with a device (10) can move about, coupled to the said management means (1, 8), and arranged to interact with each device (10) in order to obtain the associated primary identifier.

3. An installation according to claim 2, characterised in that it comprises a multiplicity of broadcast means (17-20) each associated with one of the said zones.

4. An installation according to one of claims 2 and 3, characterised in that each sensor (9-j) is associated with a secondary identifier and capable of transmitting to the management means (1, 8) the primary identifier detected and its own secondary identifier, in that each broadcast means (17-20) is associated with a tertiary identifier associated with at least one secondary identifier, in that it comprises a memory (15) in which the secondary identifiers in correspondence with each tertiary identifier are stored, and in that the said management means (1, 8) are arranged, whenever they receive primary and secondary identifiers, so as to extract from the said memory (15) the tertiary identifier associated with the secondary identifier received, so that the messaging data associated with the user identifier associated with the primary identifier received are broadcast by the broadcast means (17-20) associated with the tertiary identifier extracted from the memory (15).

5. An installation according to one of claims 1 to 4, characterised in that at least some of the said broadcast means are display means (17-19).

6. An installation according to claim 5, characterised in that at least some of the display means are monitors (17).

7. An installation according to claim 6, characterised in that at least one of the said monitors is a communications terminal monitor (2) connected to a telephony network.

8. An installation according to one of claims 5 to 7, characterised in that at least some of the said display means are image data projectors (18).

9. An installation according to one of claims 1 to 8, characterised in that at least some of the said broadcast means are acoustic broadcast means (20).

10. An installation according to one of claims 1 to 9, characterised in that the said messaging means (3, 5) comprise first electronic messaging means (3) and second telephonic messaging means (5).

11. An installation according to claim 10, characterised in that the said first electronic messaging means (3) are at least partially located in a communications terminal (2) which can be connected to an electronic messaging server via a first communications network.

12. An installation according to one of claims 10 and 11, characterised in that the said second telephonic messaging means (5) are at least partially located in a telephone (4) which can be connected to a second communications network.

13. An installation according to one of claims 11 and 12, characterised in that the said first and second communications networks are identical.

14. An installation according to one of claims 11 to 13, characterised in that each communications network is chosen from a group comprising public networks of the PSTN, PLMN, i-Mode and Internet (IP) type, and the private networks of the PABX type and private communication gateways.

15. An installation according to one of claims 1 to 14, characterised in that it comprises transmission means (B) coupled at least to the said management means (1, 8), and to the said broadcast means (17-20) and to the said detection means (9-j).

16. An installation according to claim 15, characterised in that the said transmission means (B) are chosen from a group comprising means of transmission by wave and means of transmission by cable.

17. An installation according to claim 16, characterised in that the said means of transmission by cable comprise at least data exchange buses (B).

18. An installation according to one of claims 16 and 17, characterised in that the said means of transmission by wave are infrared transceivers.

19. An installation according to one of claims 1 to 18, characterised in that each detection means (9-j) is arranged so as firstly to effect a presence detection in at least part of the zone in which it is located and secondly to send signals to the said devices (10) in the event of presence detection.

20. An installation according to one of claims 1 to 19, characterised in that it comprises a multiplicity of devices (10) associated with different primary identifiers.

21. An installation according to one of claims 1 to 20, characterised in that each device (10) is of the passive type.

22. An installation according to claim 20, characterised in that each device (10) is arranged so as to transmit its primary identifier by waves.

23. An installation according to claim 22, characterised in that the said transmission is spontaneous.

24. An installation according to the combination of claims 19 and 22, characterised in that the said transmission is carried out in response to signals transmitted by waves by the said detection means (9-j).

25. An installation according to one of claims 1 to 24, characterised in that each device (10) comprises a component (14) able to activate or deactivate its functioning in the case of actuation by a user.

26. An installation according to one of claims 1 to 25, characterised in that it comprises first conversion means able to convert messaging data of the text type into messaging data of the audible type.

27. An installation according to one of claims 1 to 26, characterised in that it comprises second conversion means able to convert messaging data of the audible type into messaging data of the text type.

28. An installation according to one of claims 1 to 27, characterised in that it comprises acoustic capture means coupled to the said management means (1, 8) and arranged so as to pick up speech emitted by a user and to convert it into digital data, and in that the said management means (1, 8) are arranged, on reception of conversion digital data, to generate, intended for the said messaging means (3, 5), commands representing messaging operations to be performed.

29. An installation according to claim 28, characterised in that the said operations are chosen from a group comprising at least the response to a chosen message, the saving or deletion of a chosen message, the selection of a chosen message from a list of messages previously displayed in the form of icons by means of a display means or broadcast in voice form by means of acoustic broadcast means, with a view to the broadcast of the data by the said display means or by the said acoustic broadcast means, the enlargement of the text data or images of a chosen message, the rebroadcasting of audible data of a chosen message, and the opening of a file attached to a chosen message.

30. An installation according to one of claims 1 to 29, characterised in that the said management means (8) are of the configurable type.

31. An installation according to claim 30, characterised in that the said configuration relates to the mode of interrogating the said messaging means (3, 5).

32. An installation according to claim 31, characterised in that the said interrogation mode is of the periodic type.

33. An installation according to one of claims 30 to 32, characterised in that the said configuration relates to a first type of messaging data to be broadcast.

34. An installation according to claim 33, characterised in that the said first type represents a first priority level which depends on the address of the sender of the messaging data received.

35. An installation according to one of claims 30 to 34, characterised in that the said configuration relates to a second type of messaging data to be broadcast.

36. An installation according to claim 35, characterised in that the said type represents a second priority level which depends on the user identifier associated with a primary identifier received.

37. An installation according to one of claims 30 to 36, characterised in that the said management means are configurable via a terminal user interface.

38. A messaging data management device (1), characterised in that it comprises management means (8) able to be used in an installation according to one of the preceding claims.

39. A management device according to claim 38, characterised in that it comprises conversion means able to be used in an installation according to one of claims 1 to 37.

40. A management device according to one of claims 38 and 39, characterised in that it comprises second conversion means able to be used in is an installation according to one of claims 1 to 37.
